(19) United States
(12) Patent Application Publication
(10) Pub. No.: US 2011/0313797 A1
(43) Pub. Date: Dec. 22, 2011

(54) CONTEXT AWARE OFFICE SPACE LOCATOR

(75) Inventor: Peter D. RUNCIE, Basking Ridge, NJ (US)

(73) Assignee: AVAYA INC., Basking Ridge, NJ (US)

(21) Appl. No.: 12/817,447

(22) Filed: Jun. 17, 2010

(51) Int. Cl. G06Q 10/00; G08B 13/14

(52) U.S. Cl. 705/5; 340/572.1

(57) ABSTRACT

The system and method provide an efficient system for scheduling office space at a site. A request is received to schedule an office space at the site. Communications and/or relationships with the person who requested the office space and other person(s) are identified. A communication can be any type of communication such as emails, voice calls, social network postings, scheduled conference rooms, and the like. A relationship can be any type of relationship such as being in the same group, being on the same project, and the like. A location(s) at the site that is associated with the other person(s) (e.g., another person's office location, a conference room location, etc.) is used to schedule the office space. This way, the office space that is scheduled is more centrally located in regard to those people with whom the requestor of the office space will be meeting/working

### TECHNICAL FIELD

The system and method relates to scheduling office space and in particular to scheduling office space based on communications or relationships.

### BACKGROUND

In recent years, the demand for shared office space has increased. This is due to various factors such as telecommuting, cost pressures, limited resources, and the like. For example, as workers telecommute more often, shared office space can be used instead of dedicated office space for the periods where workers will be in the office; thus reducing the required office space necessary and reducing fixed costs. In call centers, the use of shared office space is also increasing. In addition, unused office space can also be scheduled to accommodate visitors to a site. The visitor can reserve office space for use during his/her visit.

Current systems allow for scheduling of office space. A user can schedule the office space in the same manner as scheduling a conference room. One problem with these systems is that they do not look at the context of what the person will be doing and/or who the person will be working with when using the office space. Sometimes, the person who is scheduling the office space will not be familiar with the site or physical layout of the office space; this can lead to the person scheduling office space that is a long distance from where meetings are going to take place. What is needed is a solution that takes these problems into consideration.

### SUMMARY

The system and method are directed to solving these and other problems and disadvantages of the prior art. The system and method provide an efficient system for scheduling office space at a site. A request is received to schedule an office space at the site. Communications and/or relationships with the person who requested the office space and other person(s) are identified. A communication can be any type of communication such as emails, voice calls, social network postings, scheduled conference rooms, and the like. A relationship can be any type of relationship such as being in the same group, being on the same project, and the like. A relationship could also describe a hierarchical relationship or a reporting relationship within an organization or project. A location(s) at the site that is associated with the other person(s) (e.g., another person's office location, a conference room location, etc.) is used to schedule the office space. This way, the office space that is scheduled is more centrally located in regard to those people with whom the requestor of the office space will be meeting/working.

Another option is to allow the requestor to tag the request to schedule the office space. The tag is used to identify a purpose for the use of the office space (e.g., discussion of project XYZ). The tag is used to search through the communications/relationships to identify communications/relationships that are associated with the purpose of scheduling the office space. This way, communications/relationships that are not associated with the purpose of scheduling the office space are filtered out.

### BRIEF DESCRIPTION OF THE DRAWINGS

These and other features and advantages of the system and method will become more apparent from considering the following description of an illustrative embodiment of the system and method together with the drawing, in which:

FIG. 1 is a block diagram of a first illustrative system for scheduling office space based on a communication and/or a relationship.

FIG. 2 is a map of a site to illustrate scheduling of office space based on a communication and/or a relationship.

FIG. 3 is a flow diagram of a method for scheduling office space based on a communication and/or a relationship.

FIG. 4 is a flow diagram of a method for getting different kinds of location information in order to schedule an office space.

FIG. 5 is a flow diagram of a method of assigning weights to a person.

### DETAILED DESCRIPTION

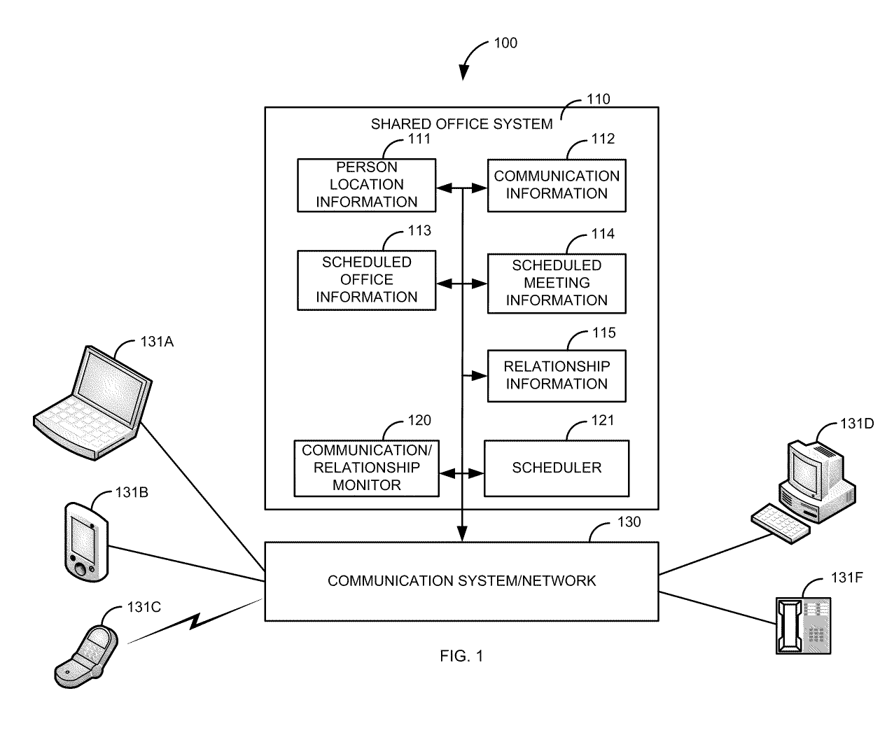

FIG. 1 is a block diagram of a first illustrative system 100 for scheduling office space based on a communication and/or a relationship. The first illustrative system 100 comprises a shared office system 110, a communication system/network 130, and communication devices 131.

Communication system/network 130 can be any type/combination of communication system/network(s) that allow communications to be sent between communication devices 131. For example, communication system/network 130 can be the Internet, a Private Branch Exchange (PBX), a router, a server, a switch, the Public Switch Telephone Network (PSTN), a cellular telephone network, an email server, a voice mail server, and the like. Communication devices 131 can be any type of communication device such as a telephone, a personal computer (PC), a Personal Digital Assistant, a laptop computer, a server, and the like.

Shared office system 110 comprises person location information 111, communication information 112, scheduled office information 113, scheduled meeting information 114, and relationship information 115. Person location information 111 contains location information about where different people at a site reside. For example, Fred Smith is in office 3C-111. Communication information 112 can contain information derived from communications between users of communication devices 131 or the actual communications themselves. Communications can be various types of communications such as emails, Instant Messages (IM), voice communications, voice mails, video communications, posts on a social network, and the like. Communication information 112 can be information that is monitored by communication/relationship monitor 120. Communication information 112 can be prior communications or current communications. Scheduled office information 113 is information about office space. This can include the schedule of each office space, who has reserved the office space, information about resources in the office space (e.g., the type of computer), the size of the office space, and the like. Scheduled office information 113 can also include a tag that is associated with a scheduled office space. The tag indicates a purpose for the scheduling of the office space. For example, the tag can indicate that the person (requestor) requesting to schedule an office space is scheduling the office space to discuss project ABC. Scheduled meeting information 114 includes information about scheduled meetings. For example, a scheduled meeting can be a meeting on July 7^{th} at 2:00 P.M. between Bob, Joe, and Sally in conference room 4B-200. Scheduled meeting information 114 can include information about the location of conference rooms, cafeterias, or any location where a meeting can take place. Relationship information 115 can include any information about a relationship with different people. For example, relationship information can contain organizational information, group information, team information, project information, and the like. Person location information 111, communication information 112, scheduled office information 113, scheduled meeting information 114, and relationship information 115 are shown as part of shared office system 110. However, shared office system 110 in some embodiments, can operate without some of these elements.

Shared office system 110 also is shown comprising communication/relationship monitor 120 and scheduler 121. Communication/relationship monitor 120 can be any hardware/software that can monitor communications on communication system/network 130. For example, communication/relationship monitor 120 can monitor emails, email chains, Instant Messages, voice mails, video communications, social network communications, and the like on communication system/network 130. Communication/relationship monitor 120 can also monitor the communications to determine relationships that are stored in relationship information 115. Scheduler 121 can be any hardware/software that can schedule resources such as a calendaring system, an inventory system, an office space management system, and the like. The elements in shared office system 110 can be in a single device/system. However, the elements in shared office system 110 can be in different devices/systems in a distributed system.

Scheduler 121 receives a request (i.e., sent from a person at a communication device 131) from a requestor to schedule an office space at a site. A requestor can be a person who requests to schedule the office space, a person on whose behalf an automated service schedules the office space, and the like. The office space is one of multiple office spaces at the site. A site can also be a single building, a group of buildings, a campus, a physical area, and the like.

Communication/relationship monitor 120 identifies a communication and/or a relationship between the requestor and a person. The relationship can be any type of relationship such as if people are in the same group, in the same organization, working on the same project, in the same family, and the like. The communication can be any type of communication, multiple communications, multiple communications in different media, and the like. The communication could be a previous email, a previous email thread, or previous Instant Message that is stored in communication information 112. The communication can be a prior voice communication and/or voice mail. The communication can be a currently monitored communication or a communication that is monitored after the request to schedule the office space is made.

For example, the communication can be a prior voice communication between the requestor (Sally) and another person (Jack) that discusses Sally's visit to Jack's facility (site) next week. The voice communication between Sally and Jack has been converted to text and stored in communication information 112. In this example, the voice communication between Sally and Jack is identified by communication/relationship monitor 120 because Jack's office is at the site of the requested office space.

Communication/relationship monitor 120 can also identify a relationship between the requestor and the person based only on a relationship stored in relationship information 115. For example, if Sally and Jack are in the same group, communication/relationship monitor 120 can identify the relationship between Sally and Jack.

Communication/relationship monitor 120 determines a location within the site that is associated with the person. For example, Jack's office (location) at Jack's facility in New Jersey (room B1-121 is at Global Positioning Satellite (GPS) Lat. 36.10238, Long. −66.70898) can be an associated location for Jack. Scheduler 121 schedules the shared office based on the location of Jack's office (i.e., the closest available office space in proximity to Jack's office). The closest proximity can be based on various factors such as an estimated time, distance, a measured walking distance, geographical distance, and the like.

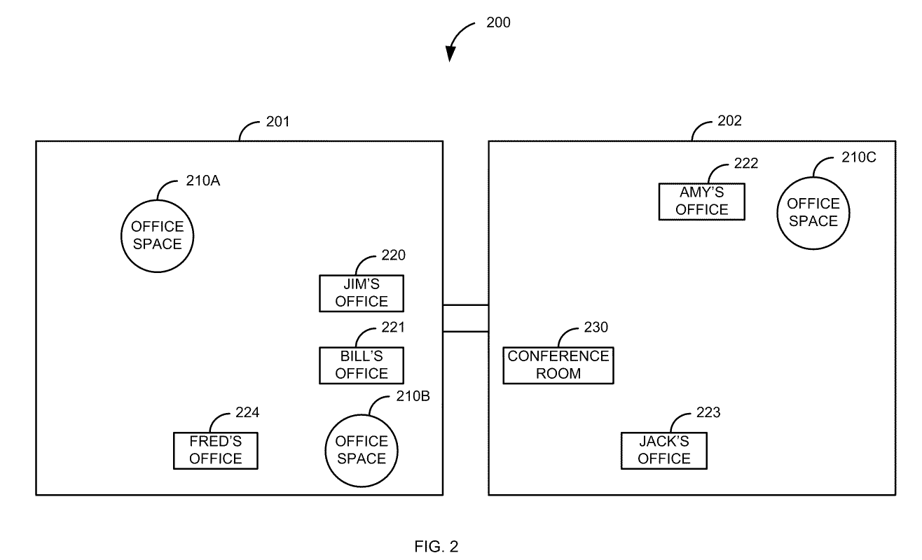

FIG. 2 is a map of a site 200 to illustrate scheduling of office space 210A-C based on a communication and/or a relationship. FIG. 2 is a map of a site 200 that comprises two buildings 201 and 202. Site 200 comprises office spaces 210A-C, Jim's office 220, Bill's office 221, Amy's office 222, Jack's office 223, Fred's office 224, and conference room 230.

To illustrate an embodiment using FIG. 2, consider the following example. Sally has an email communication (multiple emails between Sally and Amy) regarding work on project ABC with Amy in May. The communications with Amy are monitored by communication/relationship monitor 120 and stored in communication information 112. Sally and Fred have a relationship in relationship information 115 that indicates that they both are team members assigned to project XYZ.

Sally is going travel to site 200 to discuss project XYZ on June 23^{rd} and sends a request on June 3^{rd} to scheduler 121 to schedule an office space (one of 210A-210C) at site 200 on June 23. Sally tags the request with the term “Project XYZ.” Sally then has three voice communications and five emails with Jim and three emails with Bill over the next week (June 7-12) regarding project XYZ. Jim also schedules a meeting on June 23^{rd} in conference room 230 with Sally and Jack. The scheduled meeting title is “Staffing Project XYZ.” These communications are sent over communication system/network 130.

Communication/relationship monitor 120 monitors communication system/network 130 and identifies the communication between Sally and Jim, the communications between Sally and Bill, and the scheduled meeting between Sally, Jim, and Jack as related communications based on the tagged “Project XYZ” and the use of project XYZ in the communications. Communication/relationship monitor 120 also identifies that there is a relationship between Sally and Fred because they are both team members who work on project XYZ. Communication/relationship monitor 120 does not identify the communications with Amy because project XYZ was not discussed with her (only project ABC was discussed with Amy).

Based on the identified communications and relationship, communication/relationship monitor 120 determines locations in site 200 associated with Jim (Jim's office 220), Bill (Bill's office 221), Jack (Jack's office 223), Fred (Fred's office 224), and conference room 230. Scheduler 121 schedules office space 210B because it is available and is in the closest proximity to Jim's office 220, Bill's office 221, Jack's office 223, Fred's office 224, and conference room 230.

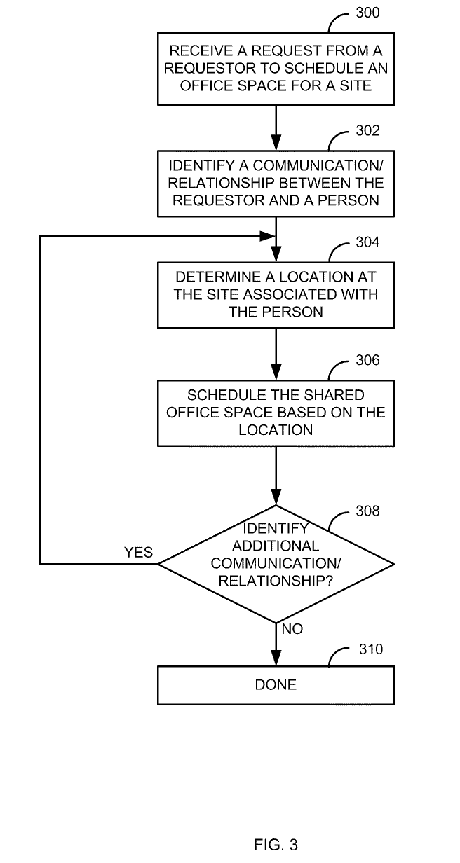

FIG. 3 is a flow diagram of a method for scheduling office space 210 based on a communication and/or a relationship. Illustratively, communication/relationship monitor 120, scheduler 121, communication system/network 130, and communication device 131 are stored-program-controlled entities, such as a computer or processor, which performs the method of FIGS. 3-5 and the processes described herein by executing program instructions stored in a tangible computer readable storage medium, such as a memory or disk. The methods of FIGS. 3-5 are shown in a particular ordering of steps. However, the methods of FIGS. 3-5 can be implemented in different orders.

The process begins when the scheduler 121 receives 300 a request from a requestor to schedule an office space 210 for site 200. The request can be sent from communication device 131, can be made from scheduler 121, and the like. Communication/relationship monitor 120 identifies 302 a communication(s) and/or a relationship between the requestor and a person(s). Communication/relationship monitor 120 determines 304 a location at site 200 that is associated with the person(s). Scheduler 121 schedules 306 office space 210B based on the location(s) associated with the person(s).

Communication/relationship monitor 120 determines in step 308 if there are any additional communication(s)/relationship(s) between the requestor and the person(s) (i.e., a communication or relationship between the requestor and a different person). If there are no more additional communications and/or relationships to identify in step 308, the process is done 310. Otherwise, if there are additional communications and/or relationships to identify in step 308, the process goes to step 304. Communication/relationship monitor 120 can then determine 304 a location(s) at site 200 associated with the person(s) in the additional communication(s) and/or relationship(s). Scheduler 121 can then automatically schedule/reschedule the office space 210A based on the location(s). This could be the same office space 210B or this could be a different office space 210A; the scheduling is done based on the location(s) associated with the persons in the additional communication(s) and/or relationship(s).

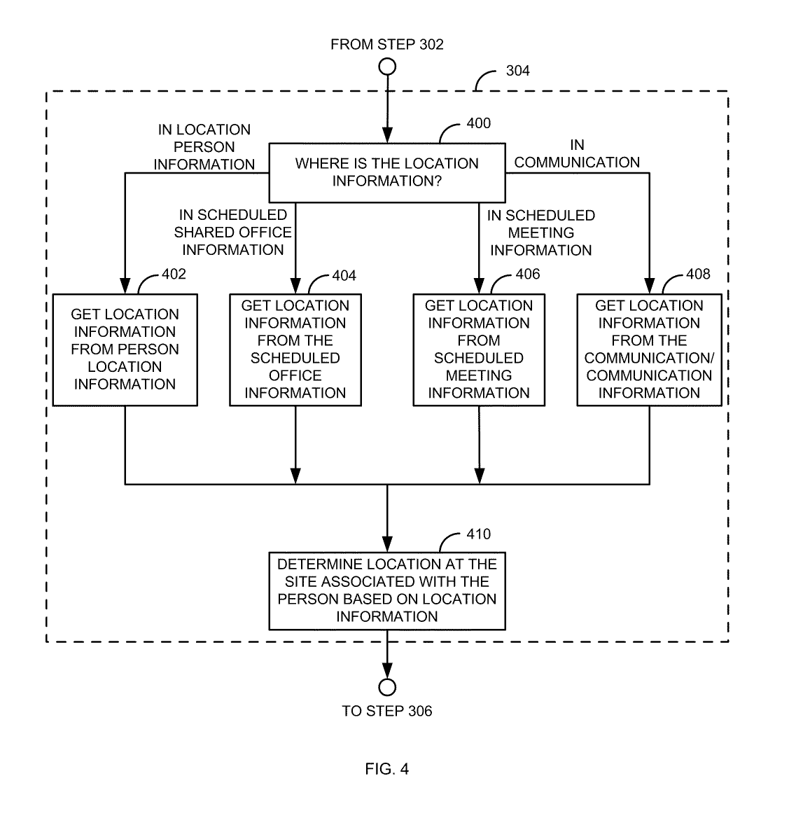

FIG. 4 is a flow diagram of a method for getting different kinds of location information in order to schedule an office space. FIG. 4 is an exemplary flow diagram of step 304 in FIG. 3. After identifying a communication and/or a relationship between the requestor and the person in step 302, communication/relationship monitor 120 determines in step 400 where the location information is. The location information can be stored in a variety of places, of which four are discussed in FIG. 4. The location information can be in one or all of person location information 111, communication information 112, scheduled office information 113, scheduled meeting information 114, and the communication(s) from the requestor to the person. The flow from step 400 to steps 402, 404, 406, and 408 can all occur or just one flow could occur.

If the location information is in person location information 111 (e.g., the person's office location), communication/relationship monitor 120 gets 402 the location information from person location information 111. If the location information is in scheduled office information 113, communication/relationship monitor 120 gets 404 the location information from scheduled office information 113. For example, if Jim and Bob were both traveling to site 200 to discuss project XYZ and Bob had previously scheduled office space 210A, scheduler 121 would take the location of office space 210A into account when scheduling the office space for Jim. This can also be used in a telecommuting/call center environment where most or all of the office space is shared. Workers can schedule office space on the days and times they will be in the office. If different workers have communications that indicate that they will be meeting and/or working on a common project when they are in, then the scheduled office space for these workers can be in the same area.

If the location information is in scheduled meeting information 114 (e.g., Bob scheduled a meeting with Jack in conference room 230), communication/relationship monitor 120 gets 406 the location information from scheduled meeting information 114. If the location information is in the communication (e.g., the communication says that they will meet in a room by the cafeteria) or in communication information 112, communication/relationship monitor 120 gets 408 the information from the communication and/or from communication information 112. Communication/relationship monitor 120 then determines 410 the location(s) at the site associated with the person(s) based on the location information. The process then goes to step 306.

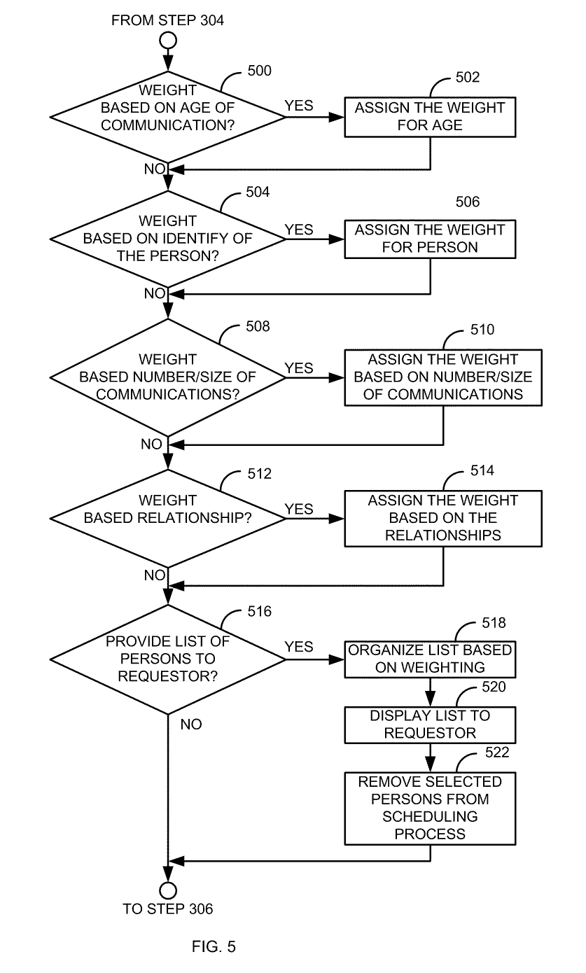

FIG. 5 is a flow diagram of a method of assigning weights to a person. FIG. 5 is an exemplary method that can be inserted between steps 304 and 306 of FIG. 3. After determining a location at the site associated with the person in step 304, scheduler 121 determines in step 500 whether to assign a weight based on the age of the communication. If scheduler 121 determines in step 500 not to assign a weight based on the age of the communication, the process goes to step 504. Otherwise, if scheduler 121 determines in step 500 to assign a weight based on the age of the communication, scheduler 121 assigns 502 the weight based on the age of the communication. For example, if a weight of 1 to 10 was assigned based on the age of the communication in days (i.e., 1 assigned to a communication 1 day old, 2 assigned to a communication 1-2 days old, and so on, (with a lower value given more weight)), then a newer communication would be given more weight than an older communication. Another way of assigning weights is to give a full weight to a communication that was sent in the last week and to not give any weight to a communication that was sent over a week ago. The process then goes to step 504.

Scheduler 121 determines in step 504 whether to assign a weight based on who the person(s) are. If schedule 121 determines in step 504 not to assign a weight based on who the person(s) are, the process goes to step 508. Otherwise, if scheduler 121 determines in step 504 to assign a weight based on who the persons are, scheduler 121 assigns 506 a weight based on who the person(s) are. For example, Sally may think that her communications with Bill are more important than those with Jim because Bill is a vice president and Jim is only an engineer. This way Sally can weight the communications with Bill more heavily when considering the location than those with Jim. The process then goes to step 508.

Scheduler 121 determines in step 508 whether to assign a weight based on the number of communications and/or the size of the communications. If scheduler 121 determines in step 508 not to assign a weight based on the number of communications and/or the size of the communications, the process goes to step 512. Otherwise, if scheduler 121 determines in step 508 to assign a weight based on the number of communications and/or the size of the communications, scheduler 121 assigns 510 a weight based on the number of communications and/or the size of the communications. For example, if Sally had 10 communications with Bill and Sally only had 1 communication with Bob on project XYZ, Bill would get a higher weighting of 10, while Bob will only get a weighting of 1. Likewise, if Bill had an email that was 100 words long and Bob had an email that was 10 words long, Bill would get a weighting of 10 times as large as Bob. These are different examples of weighting that can be used, but as one would observe, other types of weightings can be easily used. The process then goes to step 512.

Scheduler 121 determines in step 512 whether to assign a weight based on a relationship. The relationship can be a relationship with the requestor, can be a relationship between each of the persons, and the like. A weighting can be, for example, that a person working on the same project gets a higher weight than a person in the same organization. If scheduler 121 determines in step 512 that assigning a weight is not necessary, the process goes to step 516. Otherwise, if scheduler 121 determines that assigning a weight is necessary in step 516, scheduler 121 assigns 514 the weight based on the relationships. The process then goes to step 516.

Scheduler 121 determines in step 516 whether to provide a list of persons who the requestor had communications with. If there is only one person or scheduler 121 determines not to provide the list to the requestor in step 516, the process goes to step 306. Otherwise, if scheduler 121 determines in step 516 to provide the list of persons to the requestor, scheduler 121 can optionally organize 518 the list based on the weighting. Scheduler 121 displays 520 the list of persons to the requestor. Once the requestor has selected person(s) to remove, scheduler 121 removes 522 the selected person(s) from the list. The associated locations of the person(s) who are removed from the list are not considered by the schedule in step 306.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

Of course, various changes and modifications to the illustrative embodiment described above will be apparent to those skilled in the art. These changes and modifications can be made without departing from the spirit and the scope of the system and method and without diminishing its attendant advantages. The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method implemented by a processor comprising:
a. receiving from a requestor a request to schedule a first office space of a plurality of office spaces for a site;
b. identifying a communication and/or a relationship between the requestor and a person;
c. determining a location at the site associated with the person; and
d. scheduling the first office space of the plurality of office spaces based on the location.

2. The method of claim 1, wherein the location is an office of the person and the first office space is a closest available shared space by the office of the person.

3. The method of claim 1, wherein the location is a location of a second office space of the plurality of office spaces for the site and the second office space has been scheduled by the person.

4. The method of claim 1, wherein the person comprises a plurality of persons, the communication and/or relationship is a communication between the requestor and each of the plurality of persons, the determining step comprises determining a plurality of locations within the site based on the communications with the plurality of persons, and scheduling the first office space is based on the plurality of locations.

5. The method of claim 4, further comprising the step of assigning a weight to the plurality of persons based on at least one of the following: an age of the communications with the plurality of persons, an identity of the plurality of persons, a relationship of each of the plurality of persons with the requestor, a relationship of each of the plurality of persons with each other, a number of communications with the plurality of persons, a size of the communications with the plurality of persons.

6. The method of claim 4, wherein the communications with each of the plurality of persons comprises a plurality of different communication mediums.

7. The method of claim 4, further comprising the step of providing a list to the requestor to select which of the plurality of persons to use to schedule the first office space.

8. The method of claim 7, further comprising the step of organizing the list based on a weighting.

9. The method of claim 1, wherein the location is in the communication.

10. The method of claim 1, further comprising the step of identifying an additional communication after scheduling the first office space and scheduling a different office space based on the additional communication.

11. The method of claim 1, wherein identifying the communication between the requestor and the person is done based on a tag associated with scheduling the first office space.

12. A system comprising:
a. a scheduler configured to receive from a requestor a request to schedule a first office space of a plurality of office spaces for a site and schedule the first office space of the plurality of office spaces based on a location; and
b. a communication/relationship monitor configured to identify a communication and/or a relationship between the requestor and a person and to determine the location at the site associated with the person.

13. The system of claim 12, wherein the location is an office of the person and the first office space is a closest available shared space by the office of the person.

14. The system of claim 12, wherein the location is a location of a second office space of the plurality of office spaces for the site and the second office space has been scheduled by the person.

15. The system of claim 12, wherein the person comprises a plurality of persons, the communication and/or relationship is a communication between the requestor and each of the plurality of persons, the communication/relationship monitor is further configured to determine a plurality of locations within the site based on the communications with the plurality of persons, and the scheduler is further configured to schedule the first office space based on the plurality of locations.

16. The system of claim 15, wherein the scheduler is further configured to assign a weight to the plurality of persons based on at least one of the following: an age of the communications with the plurality of persons, an identity of the plurality of persons, a relationship of each of the plurality of persons with the requestor, a relationship of each of the plurality of persons with each other, a number of communications with the plurality of persons, a size of the communications with the plurality of persons.

17. The system of claim 15, wherein the communications with each of the plurality of persons comprises a plurality of different communication mediums.

18. The system of claim 15, wherein the scheduler is further configured to provide a list to the requestor to select which of the plurality of persons to use to schedule the first office space.

19. The method of claim 18, wherein the scheduler is further configured to organize the list based on a weighting.

20. The system of claim 12, wherein the location is in the communication.

21. The system of claim 12, wherein the communication/relationship monitor is further configured to identify an additional communication after scheduling the first office space and the scheduler is further configured to schedule a different office space based on the additional communication.

22. The system of claim 12, wherein identifying the communication between the requestor and the person is done based on a tag associated with scheduling the first office space.
